(19) United States
(12) Patent Application Publication
(10) Pub. No.: US 2010/0153557 A1
(43) Pub. Date: Jun. 17, 2010

(54) METHOD AND APPARATUS FOR BUILDING PERSONAL NETWORK AND NETWORK FEDERATION

(75) Inventors: Juyoung PARK, Daejeon-si (KR); Young-il CHOI, Daejeon-si (KR); Byung-sun LEE, Daejeon-si (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-si (KR)

(21) Appl. No.: 12/624,556

(22) Filed: Nov. 24, 2009

(30) Foreign Application Priority Data
Dec. 16, 2008 (KR) 10-2008-0127957

(51) Int. Cl. G06F 15/16; G06F 17/30

(52) U.S. Cl. 709/226; 707/769; 707/E17.014; 707/783; 709/246

(57) ABSTRACT

Disclosed is a method of building a personal network in a proxy server. The method includes building the personal network by registering information about a plurality of communication terminals in the proxy server through communication with the communication terminals, searching for a resource requested by a user terminal registered in the personal network, and sharing the found resource with the user terminal. The method allows a user to use own resource possessed by the user if access to the personal network of the user is possible.

### CROSS-REFERENCE TO RELATED APPLICATION

This application claims the benefit under 35 U.S.C. §119(a) of Korean Patent Application No. 10-2008-0127957, filed on Dec. 16, 2008, the disclosure of which is incorporated by reference in its entirety for all purposes.

### BACKGROUND

1. Field

The following description relates to a resource sharing technology based on a network, and more particularly, to a technology used to share resource such as files or video streaming data in a distributed computing environment.

2. Description of the Related Art

With the development of communication terminal technologies, most users generally possess or use one or more devices including an office computer, and a mobile terminal such as a mobile phone in addition to a home computer. However, possession of such devices does not guarantee access to them at all times. That is, if the user is present in a location remote from a user device, the contents stored and generated in the user device are not available to the user. Such a problem needs to be seriously considered when building a ubiquitous environment. This is because the ubiquitous environment needs to provide a user with unlimited access to resources regardless of time and place.

Meanwhile, conventional personal network technologies have been mainly developed based on methods of searching for personal equipment around the user and controlling devices around the user. In addition, the conventional personal network technologies also include a method of sharing personal resources through sharing of a personal network folder or through a file sharing agent. In the personal resource sharing method through sharing of the personal network folder, which is regarded as the easiest method of sharing user resources, the user need to access a shared remote network folder to use files stored in the corresponding folder. In addition, according to the method of sharing resources using the file sharing agent, when a predetermined resource is required, a file sharing agent system is operated such that corresponding files are selected and transferred. However, the technologies described above only regard file sharing.

### SUMMARY

Accordingly, in one aspect, there is provided a method of building a personal network, allowing a user to search for or control resources regardless of a physical location of communication devices such as a computer or a storage possessed by the user, as if all of resources stored in the devices are stored in a local storage, if access to a network of the user is possible.

In other aspect, there is provided a method of extending a range of a personal network by sharing the personal network with other user instead of exclusively possessing the personal network.

In one general aspect, there is provided a method of building a personal network in a proxy server. The method includes building the personal network by registering information about a plurality of communication terminals in the proxy server through communication with the communication terminals; searching for a resource requested by a user terminal registered in the personal network; and sharing the found resource with the user terminal.

The searching for the resource includes searching for a communication terminal storing the requested resource among the registered communication terminals.

The searching for the resource further includes checking if the user terminal is authorized to search for the resources; receiving a resource request from the user terminal if the user terminal is authorized to search for the resource; and searching for the communication terminal storing the requested resource among the registered communication terminals.

In another general aspect, there is provided a method of building a network federation in a proxy server for a personal network. The method includes building the personal network by registering information about a plurality of communication terminal in the proxy server through communication with the communication terminals; building a part of the network federation by registering information about the proxy server in a management server to build the network federation; receiving a resource request, which is generated by a user terminal belonging to another personal network of the personal network; searching for the requested resource in the personal network; and sharing the found resource with the user terminal of the another personal network.

The method further includes searching for the resource, which is requested by a user terminal in the personal network; and transferring a request to the management server such that the resource is searched in the network federation except for the personal network, if the resource requested by the user terminal is not found in the personal network.

In another general aspect, there is provided a method of building a network federation in a management server to federate personal networks. The method includes building the network federation by registering a plurality of proxy servers in the management server through communication with the proxy servers, in which a plurality of communication terminals are respectively registered in the proxy servers to build individual personal networks; receiving a resource search request which is generated by a user terminal and transferred through one of the proxy servers; and transferring the resource search request to another proxy server such that the another proxy server searches for a communication terminal storing the requested resource and allows the found resource to be shared with the user terminal.

In another general aspect, there is provided a proxy server. The proxy server includes a storage and a controller. The storage stores information used to check an authority of a user and stores a list of resources of communication terminals registered in the proxy server. The controller operates such that the personal network is built by registering information about the communication terminals in the proxy server through communication between the communication terminals and the proxy servers, a user terminal requesting for registration is registered in the proxy server by checking the authority of the user terminal with reference to the storage, a communication terminal retaining a resource requested by the registered user terminal is searched in the registered communication terminals in response to a resource request from the user terminal, and the requested resource retained in the found communication terminal is transferred to the user terminal.

The proxy server includes a data input/output unit to input and output data; and a format converter to convert a resource, which has been input to the input/output unit from the found communication terminal, in a format usable in the user terminal and then output the converted resource to the input/output unit.

In another general aspect, there is provided a network federation system. The network federation system includes: a plurality of proxy servers to build a plurality of personal networks by registering information about the communication terminals through communication with the communication terminals; and a management server to build a network federation by registering information about the proxy servers through communication with the proxy servers; wherein each proxy server searches for a communication terminal having a resource requested by a user terminal among the communication terminal registered in the network thereof in response to the resource request from the user terminal, and if the proxy server fails to find the communication terminal having the requested resource, the proxy server requests the management server to search for the requested resource in the network federation except for the personal network which has been subject to the searching operation. The management server requests another proxy server to search for a communication terminal having the resource requested by the user terminal in response to the resource request from the proxy server. The another proxy server searches for a communication terminal having the requested resource in response to the resource request submitted by the management server and shares found resource with the user terminal.

According to the present disclosure, the user can access the resource possessed by the user regardless of time and location, thereby enhancing the efficiency in use of resources. In addition, the resource possessed by the user can be shared with other users regardless of time and location.

Accordingly, the personal network building method described above can be used when building a future oriented telecommuting environment, thereby achieving a green-IT. In addition, the personal network building method can be used to build a predetermined collaboration environment such as a military network and an administration network. In addition, the personal network building method can be used in an environment in which user devices lack storage space, for example, a ubiquitous environment.

Other objects, features and advantages will be apparent from the following description, the drawings, and the claims.

### BRIEF DESCRIPTION OF THE DRAWINGS

FIG. 1 is a conceptual diagram showing an exemplary personal network (PN);

FIG. 2 is a conceptual diagram showing an exemplary personal network federation extended from a personal network;

FIG. 3 is a view showing a data transmission model implemented in a personal network (PN) environment;

FIG. 4 is a view showing a data transmission model implemented through a personal network proxy in a PN environment;

FIG. 5 is a flow chart showing a resource sharing process in a PN environment;

FIG. 6 is a flow chart showing operations of devices constituting the PN;

FIG. 7 is a flow chart showing a resource sharing process in a personal network federation (PNF) environment;

FIG. 8 is view showing a process of building a personal network federation (PNF);

FIG. 9 is a flow chart showing devices constituting a PNF;

FIG. 10 is a block diagram of a personal network (PN) system;

FIG. 11 is a block diagram of a personal network federation (PNF) system; and

FIG. 12 is a view showing a plurality of PNs constituting a PNF.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Abbreviations to be used throughout the specification are defined as follows:
PN: Personal Network
PNP: PN Proxy
PNF: PN Federation
PNU: PN User
PN-Coordinator: Management Server for PNF
PD: Personal Device

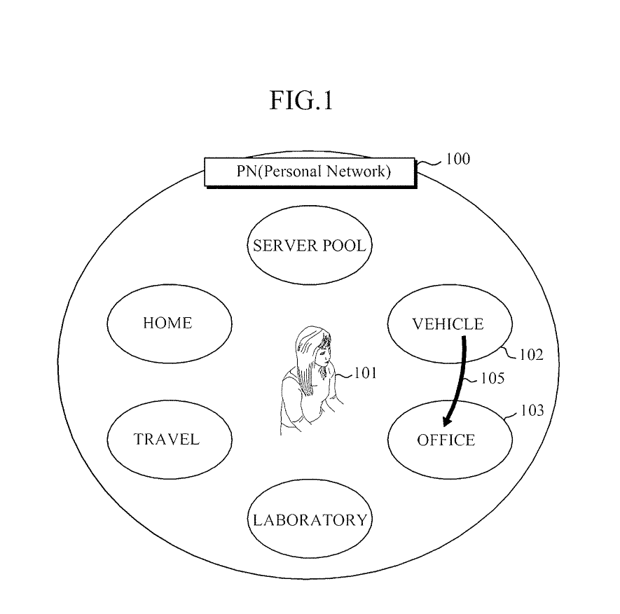

FIG. 1 is a conceptual diagram showing an exemplary personal network (PN).

A PN 100 allows a person to use resources stored in various communication devices possessed by the person regardless of time and place. For example, a PN user 101 accesses the resources, for example, contents stored in the communication device located in a vehicle 102 of the PN user 101 by operating a mobile terminal carried by the PN user 101. Further, the contents may be transferred and stored in a computer used in an office 103 of the PN user 101 (105). That is, even if the PN user 101 does not carry the communication device, the PN user 101 uses the resources stored in the communication devices possessed by the PN user 101 regardless of time and place by building a PN for all communication devices possessed by the PN user 101.

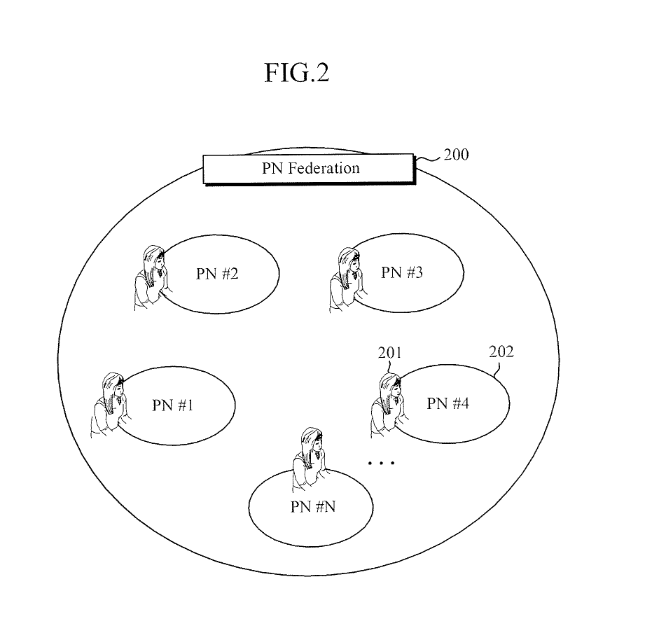

FIG. 2 is a conceptual diagram showing an exemplary personal network federation extended from a personal network.

A plurality of PNs (PN#1, PN#2, PN#3, PN#4, . . . and PN#N) form a personal network federation (PNF) 200. The PNF 200 is a network, which allows PN 202 possessed by PN users 201 to be shared with other users while providing an environment in which resources are shared between authorized PN users. The PNF 200 is aimed at allowing resources to be shared with other users. The use of the PNF 200 prevents redundant data from being stored by the PN users 201 or prevents the same resource from being repeatedly managed. Accordingly, the effective resource management can be achieved. In this regard, the sharing of resource is desirable.

Meanwhile, a right of using resources is created in the PNF 200, which is designed to enable a resource sharing between PN users. A user of resources such as files specifically creates a right of sharing the files of the user. The right of sharing resources is created such that the sharing of resources is applied to one PN user, a predetermined group of PN users, all PN users, or no PN users.

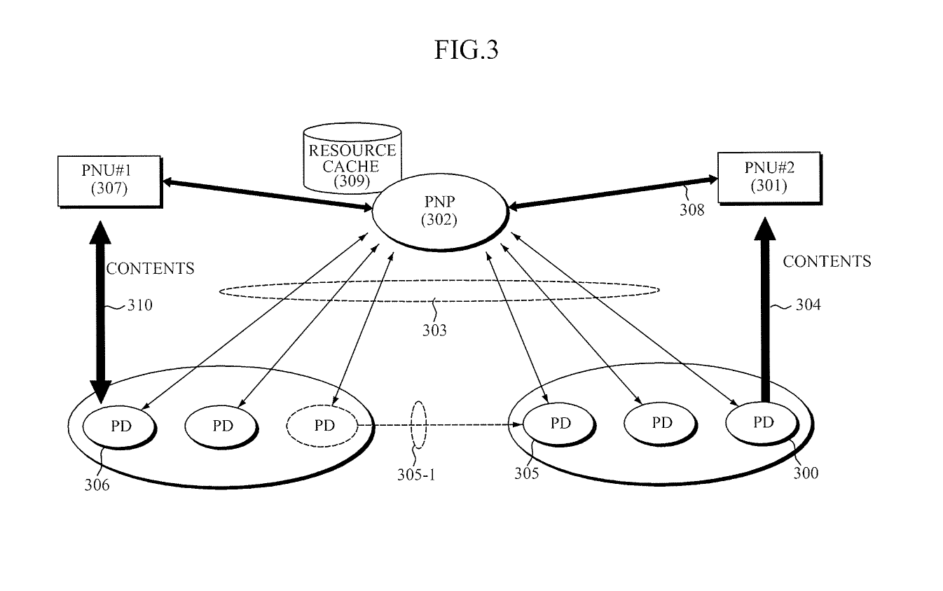

FIG. 3 is a view showing a data transmission model implemented in a personal network (PN) environment.

The data transmission model of a PNU#1 307 and a PNU#2 301 using contents stored in PDs 300 and 306 is described with reference to FIG. 3. If a plurality of PDs are distributed in a PN, information on the resources stored in the PDs and location information of the PDs are registered on a Personal Network Proxy (PNP) 302. The registration of the information will be described later. When the PNU#2 301 requests the PNP 302 (308) to provide resources, the PNP 302 searches for a PD 300, which stores the requested resource, by using a resource cache 309 implemented in the PNP 302. Names of resources and information regarding storage location of resources are stored in the resource cache 309. The PNP 302 transmits a request for sharing of a resource to the found PD 300, and informs the PNU#2 301 of a result of the request. After that, the PD 300 transfers contents to the PNU#2 301 by using location information of the PNU#2 301 which is provided from the PNP 302 (304).

Meanwhile, the PNP 302 supports the mobility of the PDs 300 and 306 and thus allows the PDs 300 and 306 to provide resources to the PNUs 301 and 307, even when the PDs 300 and 306 move from a current network to another network. Since the PDs 300 and 306 continuously and periodically register location information on the PNP 302, even if the PDs 300 and 306 change the locations, the PNP 302 allows resource sharing among the PNUs 301 and 307 and the PDs 300 and 306. For example, even if the PD 305 moves from an office to home (305-1), the PNP 302 allows the moved PD 305 to keep providing services.

Meanwhile, different from the service described above, a bi-directional data flow may be required depending on attributes of resources. For example, in the case of file editing, the transferring of resources between the PNU #1 307 and the PD 306 may be realized in both directions (310).

As an example of uni-directional resource transfer, in the case where a PNU requires a unidirectional resource transfer from a PD, the PNU requests the PD to provide a predetermined resource, such as video stream, and then receives the resource from the PD. As an example of bi-directional resource transfer, in the case where a PNU requires a bi-directional resource transfer with a PD, a packet is transmitted by the PNU and received by the PD, and vice versa.

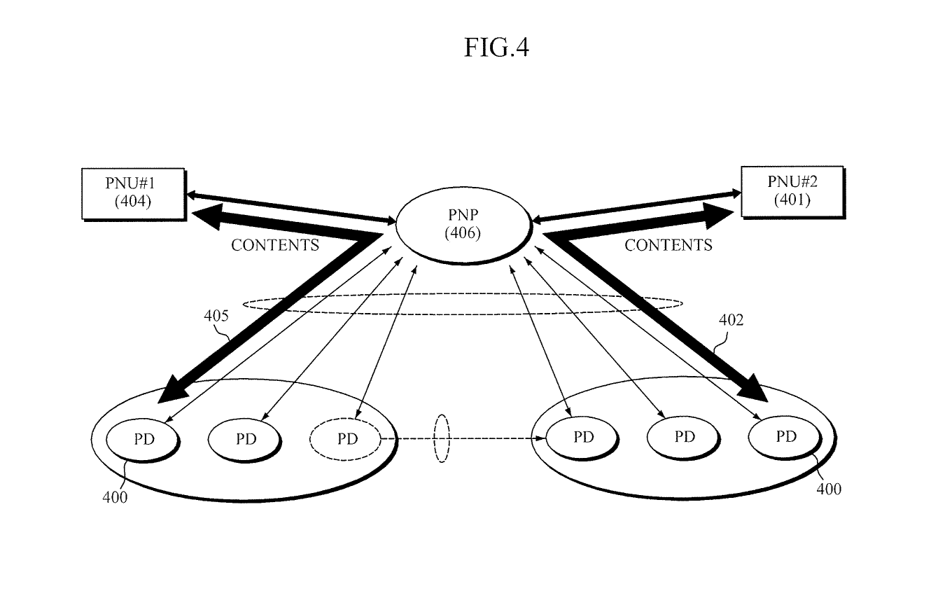

FIG. 4 is a view showing a data transmission model implemented through a personal network proxy in a PN environment. The data transmission model shown in FIG. 4 is similar to that of FIG. 3 except that resources stored in PDs 400 and 403 are indirectly transferred to PNUs through a PNP 406. Such a function of indirectly transferring data needs to be performed in two cases. In the first case, the indirect transfer of data is required when the communication between a PD and a PNU is broken due to a firewall or a Network Address Translation (NET). In the second case, the indirect transfer of data is required when a format of resources stored in a PD does not match with a format of resources required by a PNU.

As shown in FIG. 4, resources of the PDs 400 and 403 are indirectly transferred to PNUs 401 and 404 through the PNP 406 (402 and 405). The transferring of resources is performed through a uni-directional flow (402) or a bi-directional flow (405). Further, the PNP 406 may be provided with a temporary storage for storing frequently used data.

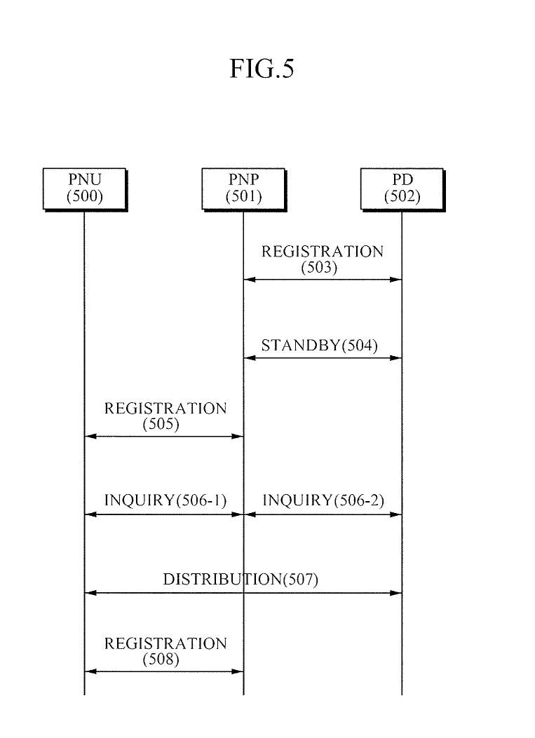

FIG. 5 is a flow chart showing a resource sharing process in a PN environment.

A PNU 500, a PNP 501 and a PD 502 form a PN. The PNU 500 is a user who requests resources of the PN. In detail, the PNU 500 is a user terminal directly handled by a user. All services of the PN are performed based on the PNP 501. To this end, the PD 502 forming the PN is registered in the PNP 501 (operation 503). A signaling for a resource sharing in the PN environment includes a request/reply operation. For example, in a registration (operation 503), if the PD 502 transmits a request for registration to the PNP 501, the PNP 501 may accept the request of the PD 502. Conversely, if the PNP 501 transmits a request for registration to the PD 502, the PD 502 may accept the request of the PNP 501. The registration process may be achieved in various fashions according to attributes and implementation schemes of the PD 502. In the case that the PD has a computing function, the PD is actively registered in the PNP. As an example of the active registration, the PD is registered in the PNP at the same time with a booting of a computer. In the case that the PD is a passive device, the PNP is registered in PDs through a polling based on location information of the PDs preset in the PNP. A protocol used during such a signaling for registration may vary with an implementation scheme of the PN system. For example, the protocol may be a session initiation protocol (SIP).

Meanwhile, after the registration has been completed, a list of resources stored in the PD 502 is provided to the PNP 501 (operation 504). The information on resources stored in the PD 502 is configured in the form of an identifier which is distinguishable in the PN. Only after an intention of involvement in the PNP 501 and a list of resources of the PDs 502 is submitted in the PNP 501, the PNU 500 uses the resources in the PN. In order for the PNU 500 to use the resources of the PN, the PNU 500 needs to be registered in the PNP 501 (operation 505).

The PNU 500 registered in the PNP 501 searches for required resources of the PN. The resources owned by the PNU 500 in the PN are searched through two schemes. The first scheme is performed when the PNU knows a location of the resources. If the PNU 500 knows that required resources ‘A’ are stored in a Personal Digital Assistant (PDA) owned by the PNU 500, the PNU 500 requests the PNP 501 to provide the resources ‘A’ stored in the PDA. The second scheme is performed when the PNU does not know a location of the resources. In this case, the PNP 500 searches for required resources in the PN.

In the searching for the resources of the PN, the PNU 500 requests the PNP 501 to search for a predetermined resource (operation 506-1). The PNP 501 inquires the PD 502, which is founded from a catalog stored in the resource cache or a database (DB) of the PNP 501 or the list on the registered PD, if the required resources are stored in the PD 502 (operation 506-2). If the PD 502 has the required resources, the PD 502 distributes the resources to the PNU 500 seeking the resources (operation 507). The transmission characteristic of resources varies depending on attributes of the resources. For example, in the case of video streaming, resources may be transferred in one direction, and in the case of a file editing, resources may be transferred in two directions. After the PNU 500 has used the resources of the PN, the PNU 500 signs off from the PN (operation 508).

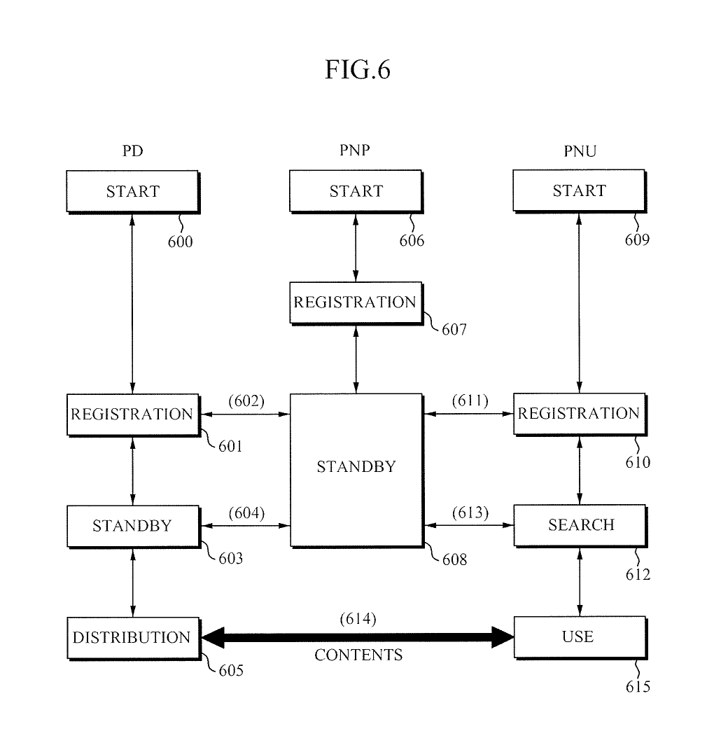

FIG. 6 is a flow chart showing operations of devices constituting the PN.

Interaction among devices including a PD, a PNP and a PNU will be described with reference to FIG. 6. The PD serves as a provider of resources, the PNU serves as a user of resources and the PNP serves as an agent between the PD and the PNU. The operations of a PNP need to precede the operations of a PN. After the PNP is initiated (operation 606), the PNP is registered (operation 607) and then enters a standby (operation 608). The registration is performed in a system environment such as a PNF environment, in which the registration of the devices is performed via a PN-Coordinator to be described later. If a system environment is configured by a single PN without a PN-Coordinator, the registration is not necessary. In the standby (operation 608), the PNP serves as an agent between the PD and the PNU.

In a registration (operation 610) of the PD, the PD is registered in the PNP (602). In that case, the communication between the PD and the PNP is performed through a request/replay scheme and an active/passive manner. According to an exemplary implementation scheme, the PD may upload a list of available resources to the PNP. After the registration has been successfully completed, the PD enters a standby for providing a PN service (operation 603).

The PNU requiring the resources is also subject to initiation (operation 609) and registration (operation 610). Since the PNU is accompanied by a user differently from the PD, the PNU may be registered in the PNP in an active manner (operation 611). After the registration of the PNU has been successfully completed, the PNU starts an operation, which is aimed to search for required resources (operation 612). The search operation forms a signal flow inquiring of the PNP regarding the required resources (613). Such a signal flow is transferred to the PD which has entered a standby (604). If the required resources are found, the PD enters a distribution (operation 605), so that contents of the PD are provided to the PNU (614). After that, the PNU enters a use of contents (operation 615) allowing the PD to use the contents provided from the PNU. After the distribution and use of the contents, the PNU and PD transit into the search (operation 612) and standby (operation 603) modes, respectively.

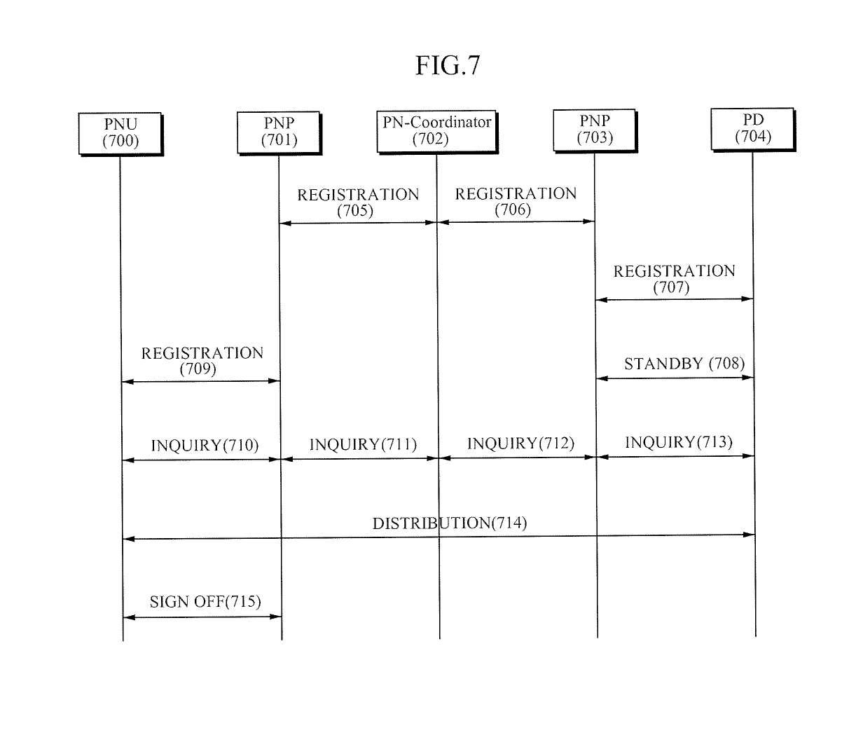

FIG. 7 is a flow chart showing a resource sharing process in a personal network federation (PNF) environment. The resource sharing process shown in FIG. 7 is similar to that of FIG. 5 except that a plurality of PNs are united to configure a PNF. As shown in FIG. 7, the PNF is configured by adding a PN-Coordinators 702. PNPs 701 and 703, which have detected the existence of the PN-Coordinator 702, are registered in the PN-Coordinator 702, thereby informing the PN-Coordinator 702 of the existence of PNPs 701 and 703(operations 705 and 706). In addition, a PD 704 is registered in the PNP 703 (operation 707) and enters a standby mode (operation 708). Accordingly, the registration and standby mode in a single PN is completed.

In such a PNF environment, a PNU 700 requiring resources is registered in the PNP 701 of a PN to which the PNU 700 belongs (operation 709). After the PNU 700 has successfully performed the registration, the PNU 700 requests the PNP 701 to provide required resources through an inquiry (operation 710). The PNP 701 searches for the requested resources in the PN to which the PNU 700 belongs. If the requested resources do not exist in the PN, the PNP 701 requests the PN-Coordinator 702 to transfer a resource search inquiry to another PNP 703, which forms the PNF in cooperation with the PNP 701 (operation 711). The PN-Coordinator 702 transfers the inquiry to the PNP 703 (operation 712), and the PNP 703 inquires of the PD 704 whether the PD 704 has the required resources (operation 713). According to an exemplary embodiment, the PN-Coordinator 703 has a capability of transferring an inquiry to all of the PNPs in the PNF. According to an exemplary embodiment, the PN-Coordinator may transfer the inquiry to all of the united PNPs. According to another exemplary embodiment, the PN-Coordinator may sequentially transfer an inquiry as follows. First, a PN-Coordinator transfers an inquiry for requesting resources to a PNP. If the PN-Coordinator receives a result of the inquiry indicating that the required resources do not exist in the PNP, the PN-Coordinator transfers an inquiry for requesting resources to another PNP. If it is found that the PD 704 has the required resources and the resources are allowed to be shared, the resources of the PD 704 are distributed to the PNU 700 requiring the resources (operation 714). After the use of the resource sharing service provided by the PNF, the PNU 700 signs off from the PN (operation 715).

The PNP manages information described below, thereby providing the PN service to the PNU.

1) PD information: ‘name of resources (title, contents tag)’, ‘location of resources including location of PD’

2) PNU information including authorization information: ‘user of resources’, ‘a person allowed to use resources’ and a handle used for adjusting the authorization of other user groups.

3) Other information for defining characteristics of a PN provider Meanwhile, an authorization process and additional functions of the PD and PNU are performed when the PD and PNU are registered in the PNP. Similarly, an authorization process of the PNP is performed when the PNP is registered in the PN-Coordinator. According to an exemplary embodiment, the authorization is not important when a system environment is implemented as a single PN. However, in the case that a PNF is configured, the authorization is important in creating an authority of the PNU. That is, an additional signaling for the authorization is not important in a signaling flow for sharing resources.

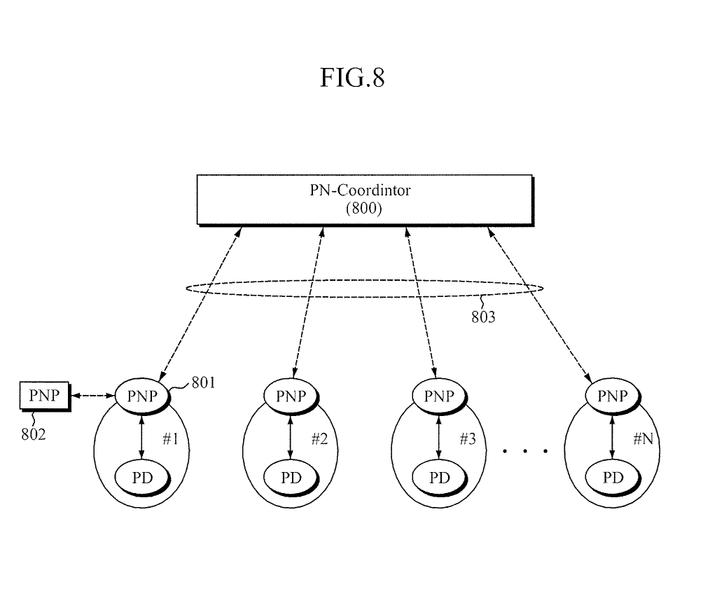

FIG. 8 is view showing a process of building a personal network federation (PNF).

In order to build a PNF by uniting a plurality PNs, a PN-Coordinator 800 is required. PNPs 801 included in respective PNs form the PNF by performing a signaling with respect to the PN-Coordinator 800 (803). The PNF provides the PNU 802 with a transparency between PNs. As shown in FIG. 8, on the assumption that the PN-Coordinator 800 weaves a plurality of PNs into a single PN, the transparency represents that the PNU 802 has permission to use resources contained in other PNs regardless of locations of the resource in the PNF.

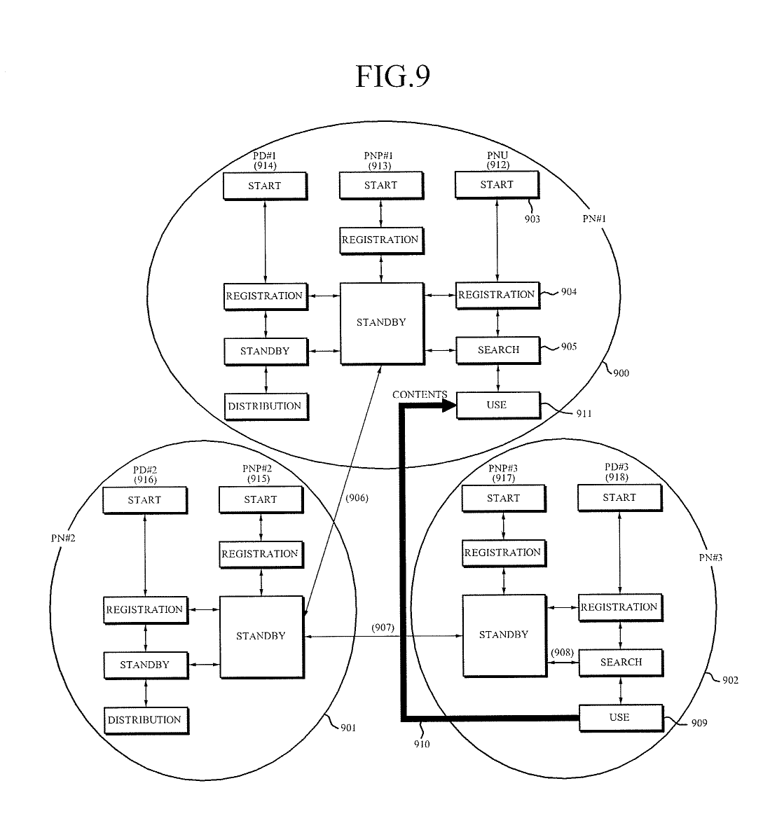

FIG. 9 is a flow chart showing devices constituting a PNF.

A PNF is a set of individual PNs, and each of the PNs operates in the same manner shown in FIG. 6. The PNF includes a PN#1 900, a PN#2 901 and a PN#3 902 that serve as individual PNs. A PNU 912 belonging to the PN#1 900 is sequentially subject to initiation (operation 903) and registration (operation 904), which are performed for a resource sharing, and then performs a search for required resources (operation 905). In detail, a PNP#1 913 of the PN#1 900 searches for resources in a PD#1 914 constituting the PN#1 900. If the resources requested by the PNU 912 are not found in the PN#1 900, the PNP#1 913 transfers a resource search request to a PNP#2 915 adjacent to the PNP#1 913 (operation 906). If the PNP#2 915 fails to find the resources requested by the PNU 912 in the PN#2 901, the PNP#2 915 transfers a resource search request to a PNP#3 917 adjacent to the PNP#2 915 (operation 907). The PNP#3 917 finds a PD#3 918 containing the resources requested by the PNU 912, and requests the PD#3 918 to distribute the resources (operation 908). The PD#3 918 distributes the resources to the PNU 912 (operation 910), and the PNU 912 receives and uses the requested resources (operation 911).

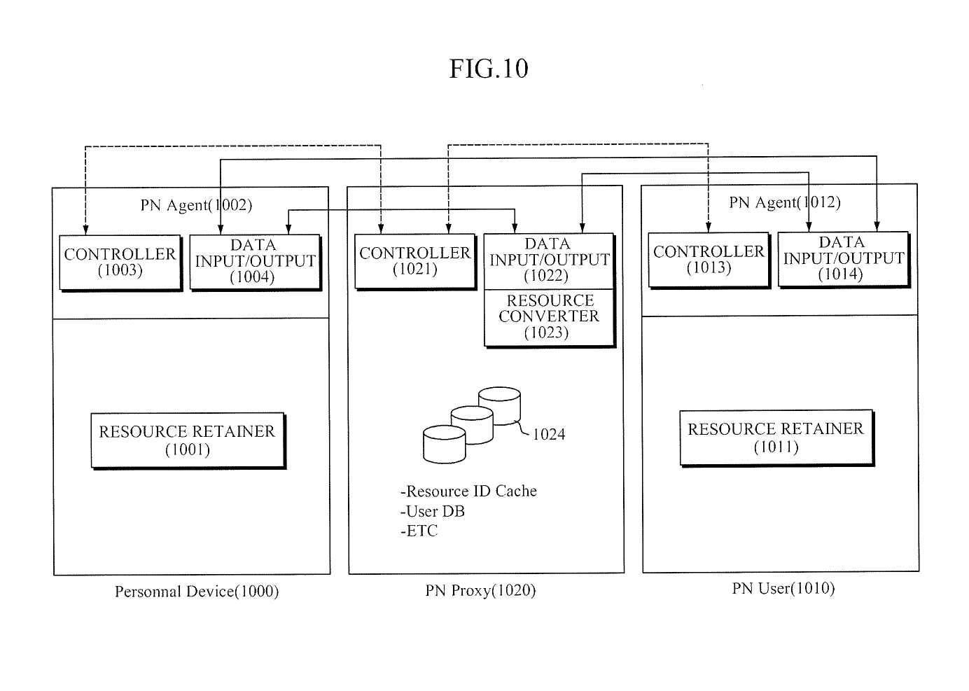

FIG. 10 is a block diagram of a personal network (PN) system including a PD 1000, a PNU 1010 and a PNP 1020.

The PD 1000 includes a resource retainer 1001 to retain resources, such as contents for example files or streaming data, and a PN agent 1002 for implementing a PN. The PN agent 1002 includes a controller 1003 and a data input/output unit 1004. The controller 1003 performs a signaling for registration/signing off of the PD 1000 in/from the PN and a signaling for resource searching in the PN. The data input/output unit 1004 is responsible for input/output of the resources. The PNU 1010 is a user terminal which is directly operated by a user, and includes a resources retainer 1011 and a PN agent 1012 including a controller 1013 and a data input/output unit 1014. The configuration of the PNU 1010 identical to that of the PD 1000 will be omitted in order to avoid redundancy.

The PNP 1020 is a proxy server serving as a main part of the PN, and may be embodied as a device belonging to the PN or as an additional device similar to a home gateway. The PNP 1020 includes a controller 1021 and a data input/output unit 1022. The controller 1021 performs a signaling with the controller 1003 of the PD 1000, thereby managing the registration/signing off of the PD 1000 in/from the PN and the resource search in the PD. The data input/output unit 1022 manages input/output of resources. Resources may be transmitted/received between a PD and a PD, a PD and a PNU or a PNU and a PNU through respective input/output units of the PD, the PNU and the PNU.

Meanwhile, the PNP 1020 further includes a format converter 1023. The format converter 1023 is coupled to the data input/output unit 1022. The format converter 1023 converts a format of contents of the PD 1000 and the PNU 1010 such that files of the PD 1000 and the PNU 1010 are provided in various formats. According to an exemplary embodiment, the format converter 1023 performs a codec conversion including the conversion of compression ratio and the alteration of codec. In addition, the format converter 1023 performs a conversion of content formats, for example, conversion of text format and conversion of voice format. If resources are indirectly transferred from the PD 1000 to the PNU 1010 through the PNP 1020, the format converter 1023 converts a format of the resources such that the resource are available in the PNU 1010. In addition, the PNP 1020 includes a database 1024. The database 1024 includes a database of a user allowed to use the PN and a resource cache corresponding to information on resources stored in the PN. The resource cache stores a name of resources and information on location where resource are stored.

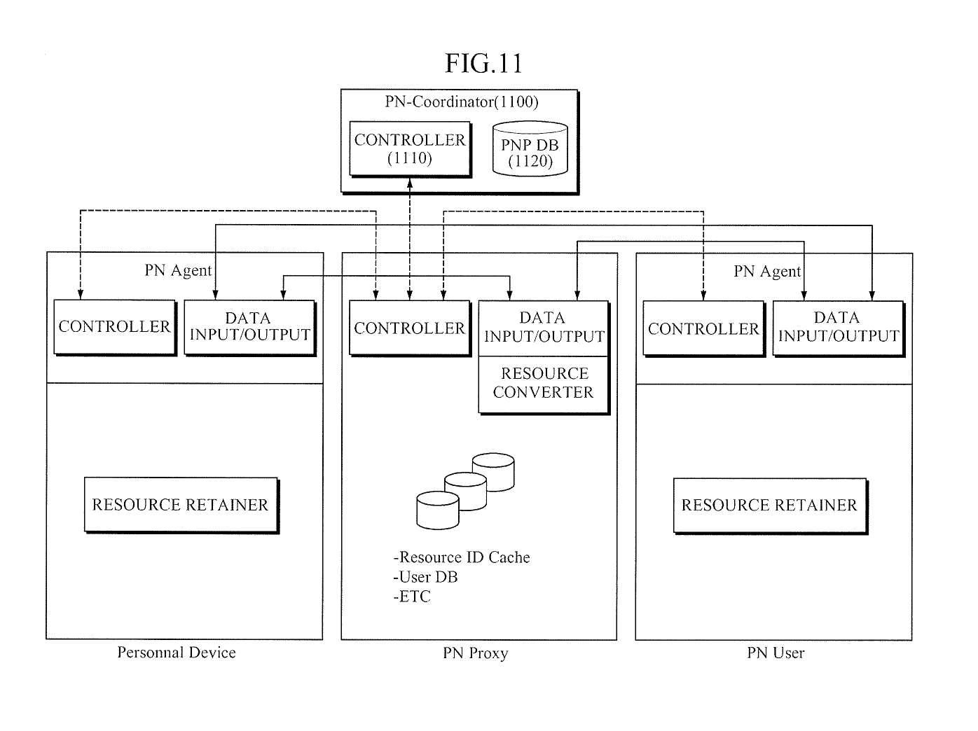

FIG. 11 is a block diagram of a personal network federation (PNF) system.

A PNF system further includes a PN-Coordinator 1100 in addition to the configuration shown in FIG. 3. The PN-Coordinator 1100 includes a controller 1110 and a PNP DB 1120. The controller 1100 manages a registration of PNPs and enables a virtual routing such as an overlay networking between PNPs. The controller 1110 performs signaling to build a PNF by uniting PNs, which have resources required by the PNPs, with each other using a PNP list.

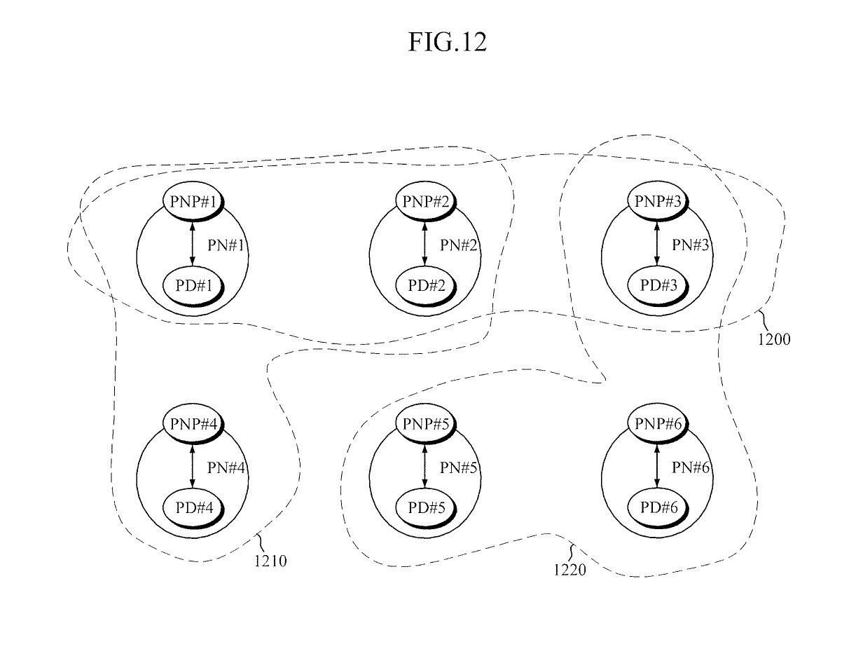

FIG. 12 is a view showing a plurality of PNs constituting a PNF. Each of a PN#1 to a PN#6 includes a plurality of registered PDs. Such PNs are united to form a large-scaled virtual PN, that is, a PNF. A PN-Coordinator provides a PNP#1 to a PNP#6 with a list of predetermined PNPs forming a PNF. As shown in FIG. 12, the PN#1, the PN#2 and the PN#3 form a PNF 1200. The PN#1, the PN#2 and the PN#4 form a PNF 1210. The PN#3, the PN#5 and the PN#6 form a PNF 1220. As shown in FIG. 12, a single PN may belong to different PNFs at the same time.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A method of building a personal network in a proxy server, the method comprising:
building the personal network by registering information about a plurality of communication terminals in the proxy server through communication with the communication terminals;
searching for a resource requested by a user terminal registered in the personal network; and
sharing the found resource with the user terminal.

2. The method of claim 1, wherein the searching for the resource comprises searching for the requested resource in an internal database storing a resource provided by at least one of the communication terminals.

3. The method of claim 1, wherein the searching for the resource comprises searching for a communication terminal storing the requested resource among the registered communication terminals.

4. The method of claim 3, wherein the searching for the resource further comprises:
checking if the user terminal is authorized to search for the resource;
receiving a resource request from the user terminal if the user terminal is authorized to search for the resource; and
searching for the communication terminal storing the requested resource among the registered communication terminals.

5. The method of claim 4, wherein, in the sharing of the resource, the found communication terminal directly transfers the requested resource to the user terminal.

6. The method of claim 3, wherein the sharing of the resource comprises:
receiving the requested resource from the found communication terminal; and
transferring the received resource to the user terminal.

7. The method of claim 6, wherein the transferring of the resource comprises:
converting a format of the received resource into a format usable by the user terminal; and
transferring the resource in the changed format to the user terminal.

8. A method of building a network federation in a proxy server for a personal network, the method comprising:
building the personal network by registering information about a plurality of communication terminal in the proxy server through communication with the communication terminals;
building a part of the network federation by registering information about the proxy server in a management server to build the network federation;
receiving a resource request, which is generated by a user terminal belonging to another personal network of the personal network;
searching for the requested resource in the personal network; and
sharing the found resource with the user terminal of the another personal network.

9. The method of claim 8, wherein the searching for the resource comprises searching for the requested resource in an internal database storing resource provided by at least one of the communication terminals.

10. The method of claim 8, wherein the searching for the resource comprises searching for a communication terminal among the registered communication terminals storing the resource requested by the user terminal.

11. The method of claim 8, further comprising:
searching for the resource, which is requested by a user terminal in the personal network; and
if the resource requested by the user terminal is not found in the personal network, transferring a request to the management server such that the resource is searched in the network federation except for the personal network.

12. The method of claim 11, further comprising:
receiving the resource found in the network federation;
converting a format of the received resource into a format usable in the user terminal; and
transferring the resource in the changed format to the user terminal.

13. A method of building a network federation in a management server to federate personal networks, the method comprising:
building the network federation by registering a plurality of proxy servers in the management server through communication with the proxy servers, in which a plurality of communication terminals are respectively registered in the proxy servers to build individual personal networks;
receiving a resource search request which is generated by a user terminal and transferred through one of the proxy servers; and
transferring the resource search request to another proxy server such that the another proxy server searches for a communication terminal storing the requested resource and allows the found resource to be shared with the user terminal.

14. The method of claim 13, wherein the sharing of the resource with the user terminal comprises:
checking if a user possessing the user terminal has an authority for sharing resource set by a user of the found communication terminal; and
sharing the requested resource if the user has the authority.

15. A proxy server for building a personal network, the proxy server comprising:
a storage to store information used to check an authority of a user and to store a list of resource of communication terminals registered in the proxy server;
a controller to operate such that the personal network is built by registering information about the communication terminals in the proxy server through communication between the communication terminals and the proxy servers, a user terminal requesting for registration is registered in the proxy server by checking the authority of the user terminal with reference to the storage, a communication terminal retaining a resource requested by the registered user terminal is searched in the registered communication terminals in response to a resource request from the user terminal, and the requested resource retained in the found communication terminal is transferred to the user terminal.

16. The proxy server of claim 15, further comprising:
a data input/output unit to input and output data; and
a format converter to convert a resource, which has been input to the input/output unit from the found communication terminal, in a format usable in the user terminal and then output the converted resource to the input/output unit.

17. A network federation system comprising:
a plurality of proxy servers to build a plurality of personal networks by registering information about the communication terminals through communication with the communication terminals; and
a management server to build a network federation by registering information about the proxy servers through communication with the proxy servers;
wherein each proxy server searches for a communication terminal having a resource requested by a user terminal among the communication terminal registered in the network thereof in response to the resource request from the user terminal, and if the proxy server fails to find the communication terminal having the requested resource, the proxy server requests the management server to search for the requested resource in the network federation except for the personal network which has been subject to the searching operation,
the management server requests another proxy server to search for a communication terminal having the resource requested by the user terminal in response to the resource request from the proxy server, and
the another proxy server searches for a communication terminal having the requested resource in response to the resource request submitted by the management server and shares found resource with the user terminal.
